(19) United States
(12) Patent Application Publication
(10) Pub. No.: US 2026/0177451 A1
(43) Pub. Date: Jun. 25, 2026

(54) OPTICAL DEVICE AND METHOD FOR DETERMINING PARAMETERS OF THE SAME

(71) Applicant: Taiwan Semiconductor Manufacturing Company, Ltd., Hsinchu (TW)

(72) Inventors: Chia-Wei CHIANG, Hsinchu (TW); Sheng Kai YEH, Hsinchu (TW); Shao-Da WANG, Hsinchu (TW); Lian Wee LUO, Hsinchu (TW); Chi-Yuan SHIH, Hsinchu (TW); Chun-Pei WU, Hsinchu (TW); Tse-En CHANG, Hsinchu (TW)

(73) Assignee: Taiwan Semiconductor Manufacturing Company, Ltd., Hsinchu (TW)

(21) Appl. No.: 19/001,140

(22) Filed: Dec. 24, 2024

(51) Int. Cl. G01M 11/00; G02F 1/025

(52) U.S. Cl. CPC G01M 11/00; G02F 1/025; G02F 2203/15

(57) ABSTRACT

A method for determining parameters of an optical device including a first waveguide and a resonator is provided. The method includes coupling a light signal from the first waveguide to the resonator. The resonator includes a first P/N junction and a ring waveguide, and the first P/N junction is configured to modulate a resonant frequency of the resonator until the light signal is resonant in the resonator. The method further includes detecting a resonant spectrum of the light signal from a through port of the first waveguide, and determining parameters of the optical device based on the resonant spectrum of the light signal.

### BACKGROUND

Optical devices, such as optical modulators or phase shifters are very promising for providing a high data transmission rate, an ultra-low power consumption, and a small footprint (or size) for high-speed data communication systems. Determining modulator parameters, such as optical loss and the refractive index, is essential for evaluating performance and creating a simulation program with integrated circuit emphasis (SPICE) models for circuit design. However, most of the test keys, which use large cutback waveguides, have diameters in the millimeter range, and the number of tests that can be performed on a single test vehicle tape-out is limited. As such, advances in the field of forming a modulator are necessary to reduce the overall size of the optical device and improve the accuracy of determining the parameters of the optical device. Further improvements are needed in order to meet the desired design criteria such that high-speed data communication for optical devices may be maintained.

### BRIEF DESCRIPTION OF THE DRAWINGS

The present disclosure is best understood from the following detailed description when read with the accompanying figures. It is emphasized that, in accordance with the standard practice in the industry, various features are not drawn to scale and are used for illustration purposes only. In fact, the dimensions of the various features may be arbitrarily increased or reduced for clarity of discussion.

FIG. 1 illustrates a process flow of operating an optical device, according to embodiments of the disclosure.

FIG. 2 illustrates a diagram of an optical device used in the process flow, according to embodiments of the present disclosure.

FIG. 3 illustrates a diagram of resonant spectrums of a light signal, according to embodiments of the present disclosure.

FIG. 4 illustrates a diagram of an optical device used in the process flow, according to embodiments of the present disclosure.

FIG. 5 illustrates a diagram of an optical device used in the process flow, according to embodiments of the present disclosure.

FIG. 6 schematically illustrates an example resonator used in the process flow, according to embodiments of the present disclosure.

FIG. 7 schematically illustrates an example resonator used in the process flow, according to embodiments of the present disclosure.

FIG. 8 schematically illustrates an example resonator used in the process flow, according to embodiments of the present disclosure.

FIG. 9 schematically illustrates an example resonator used in the process flow, according to embodiments of the present disclosure.

FIG. 10A illustrates a diagram showing an external configuration of a computer system for operating a micro-ring modulator according to embodiments of the present disclosure.

FIG. 10B illustrates a diagram showing an internal configuration of a computer system for operating a micro-ring modulator according to embodiments of the present disclosure.

### DETAILED DESCRIPTION

It is to be understood that the following disclosure provides many different embodiments, or examples, for implementing different features of the disclosure. Specific embodiments or examples of components and arrangements are described below to simplify the present disclosure. These are, of course, merely examples and are not intended to be limiting. For example, dimensions of elements are not limited to the disclosed range or values, but may depend upon process conditions and/or desired properties of the device. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact. Various features may be arbitrarily drawn in different scales for simplicity and clarity.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The device may be otherwise oriented (rotated 90 degrees or at other orientations) and the spatially relative descriptors used herein may likewise be interpreted accordingly. In addition, the term “made of” may mean either “comprising” or “consisting of.”

Determining modulator parameters, such as optical loss and the refractive index, requires test keys with large cutback waveguides to provide sufficient phase change and signal attenuation. However, the large sizes of the test keys limit the number of tests on a single test vehicle tape-out. In addition, measurements of modulator parameters of the test keys with large cutback waveguides are also affected by the fiber-grating coupling conditions. Embodiments of this disclosure provide an improved optical modulator with a ring resonator for extracting optical parameters, thereby reducing the overall size of the modulator. For example, a ring resonator having bending waveguides that modulate the optical signal by a P/N junction reduces the overall size of the optical modulator. In addition, the optical modulator with the ring resonator is less sensitive to variations, such as fiber-grating coupling conditions. As a result, methods of determining the parameters of the optical device can be improved, thereby enabling high-speed data communication for optical devices.

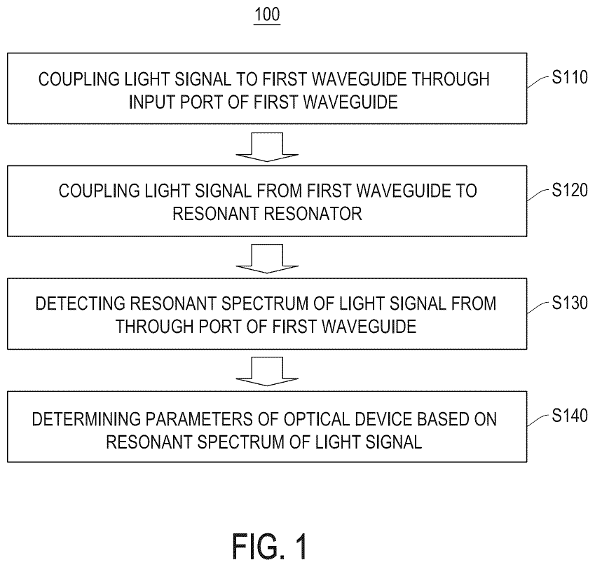

FIG. 1 illustrates a process flow 100 of operating an optical device, according to embodiments of the disclosure.

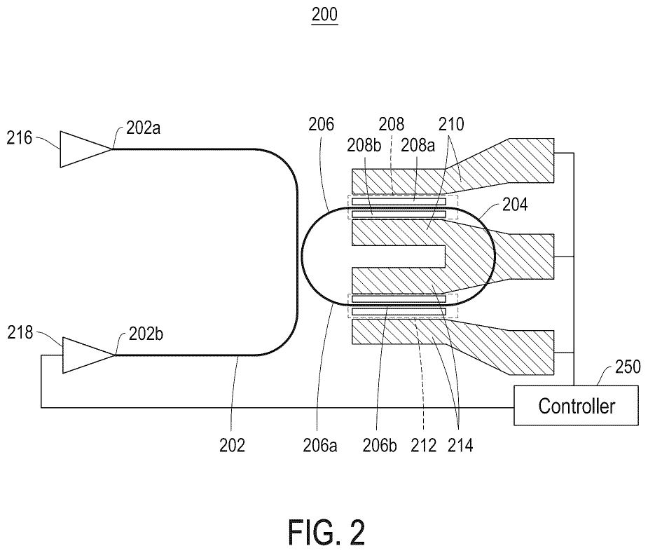

FIG. 2 illustrates a diagram of an optical device 200 used in the process flow 100 of FIG. 1, according to embodiments of the present disclosure. In some embodiments, the optical device 200 is an optical modulator. In some embodiments, the optical device 200 is a micro-ring modulator. In some embodiments, the optical device 200 is a test key for evaluating performance and creating a simulation program with integrated circuit emphasis (SPICE) models for circuit design.

In some embodiments, as shown in FIG. 2, the optical device 200 includes a first waveguide 202 and a resonator 204 positioned adjacent to the first waveguide 202. The resonator 204 is configured to couple a light signal from the first waveguide 202 to the resonator 204. In some embodiments, the resonator 204 is formed using silicon-on-insulator (SOI) technology, i.e. including a silicon-insulator-silicon structure, where the insulator may be a buried oxide layer. In some embodiments, the resonator 204 is formed with other semiconductor materials including elements from the IV-IV groups and III-V group to guide the light signal within the resonator 204. Alternatively, in some embodiments, the resonator 204 is formed with LiNbO3.

In some embodiments, the light signal includes a plurality of multiplexed wavelengths. The resonator 204 is configured to modulate the light signal to resonate at a resonant wavelength λᵣ.

In some embodiments, the first waveguide 202 is a bus waveguide. The first waveguide 202 includes an input port 202a and a through port 202b. In some embodiments, the first waveguide 202 is configured to couple the light signal from an input port 202a of the first waveguide 202 to the first waveguide 202. For example, as illustrated in operation S110 of FIG. 1, the light signal is transmitted and/or coupled from a light source (not shown) by a first grating coupler 216 to the input port 202a of the first waveguide 202.

In some embodiments, the light signal is transmitted through the first waveguide 202. The light signal includes light with multiple wavelengths and the multiple wavelengths are multiplexed and transmitted through the first waveguide 202. In some embodiments, the light signal enters the input port 202a of the first waveguide 202. In some embodiments, the light signal is further modulated by the resonator 204 and transmitted to a through port 202b of the first waveguide 202.

In some embodiments, as shown in FIG. 2, the resonator 204 includes a ring waveguide 206 and a first P/N junction 208. In some examples, the ring waveguide 206 has a loop structure. The ring waveguide 206 includes bending portions 206a and straight portions 206b. The bending portions 206a and the straight portions 206b are connected and/or coupled to form the loop structure. In some embodiments, the ring waveguide 206 is circular shaped. In some embodiments, the ring waveguide 206 is racetrack-shaped.

In some embodiments, the first waveguide 202 is positioned adjacent to bending portions 206a to couple to the resonator 204. For example, as illustrated in operation S120 of FIG. 1, the light signal is transmitted and/or coupled from the first waveguide 202 to the resonator 204.

The first P/N junction 208 is configured to modulate a resonant frequency of the resonator 204, such that the light signal is resonant at the resonant wavelength/in the resonator 204.

In some embodiments, a portion of the ring waveguide 206 is doped to form the first P/N junction 208. In some embodiments, as shown in FIG. 2, the first P/N junction 208 is positioned at the straight portions 206b of the ring waveguide 206 by doping the straight portions 206b of the ring waveguide 206.

In some embodiments, as shown in FIG. 2, the first P/N junction 208 includes a first doped portion 208a and a second doped portion 208b to form the P/N junction. In some embodiments, a portion of the ring waveguide 206 is doped to form the first doped portion 208a and the second doped portion 208b. In some embodiments, the first doped portion 208a and the second doped portion 208b are formed and positioned adjacent to the ring waveguide 206. In some embodiments, the first doped portion 208a and the second doped portions 208b have a dopant concentration in a range from about 1 e¹⁶/cm³ to about 1 e¹⁹/cm³. In some embodiments, the first doped portion 208a and the second doped portions 208b have a dopant concentration in a range from about 1 e¹⁷/cm³ to about 1 e¹⁸/cm³.

In some embodiments, the first doped portion 208a has a first dopant type and the second doped portion 208b has a second dopant type. The first dopant type is opposite to the second dopant type. In some examples, the first doped portion 208a has an n-type dopant and the second doped portion 208b has a p-type dopant. Alternatively, in some examples, the first doped portion 208a has a p-type dopant and the second doped portion 208b has an n-type dopant. In some embodiments, the n-type dopant is phosphorus, arsenic, and/or antimony. In some embodiments, the p-type dopant is boron, indium, and/or gallium.

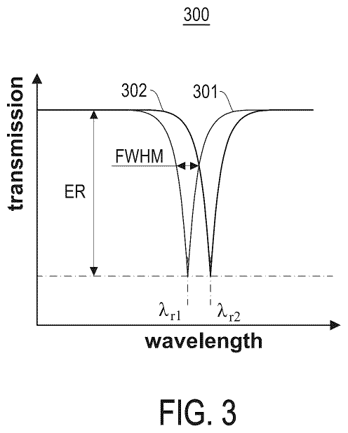

In some embodiments, the optical device 200 further includes first electrical pads 210 configured to apply a first bias voltage to the first P/N junction 208. The first bias voltage is applied to the first P/N junction 208, such that a first depletion region forms within the ring waveguide 206. The size of the first depletion region changes when the first bias voltage changes, thereby changing the effective refractive index of the resonator 204. The modulation of the effective refractive index modulates the resonant wavelength of the ring waveguide 206 accordingly, which changes the transmittance of the first waveguide 202 at the corresponding carrier wavelength, thereby modulating the intensity thereof and generating the corresponding resonant spectrum of the light signal (also see FIG. 3). In some embodiments, the bias voltage is in a range from 0 volts to 0.7 volts. In some embodiments, the bias voltage is in a range from 0 volts to 0.3 volts.

In some embodiments, the resonator 204 further includes a second P/N junction 212. The second P/N junction 212 is configured to further modulate the resonant frequency of the resonator, such that the light signal is resonant at the resonant wavelength λᵣ in the resonator 204. In some embodiments, the second P/N junction 212 is similar to the first P/N junction 208.

In some embodiments, a portion of the ring waveguide 206 is doped to form the second P/N junction 212. In some embodiments, as shown in FIG. 2, the second P/N junction 212 is positioned at the straight portions 206b of the ring waveguide 206 by doping the straight portions 206b of the ring waveguide 206. In some embodiments, the dopant concentration of the second P/N junction 212 has a same range of the dopant concentration of the first P/N junction 208.

In some embodiments, the optical device 200 further includes second electrical pads 214 configured to apply a second bias voltage to the second P/N junction 212. The second bias voltage is applied to the second P/N junction 212, such that a second depletion region forms within the ring waveguide 206. The size of the second depletion region changes when the second bias voltage changes, thereby further changing the effective refractive index of the resonator 204.

In some embodiments, as shown in FIG. 2, the first P/N junction 208 and the second P/N junction 212 are positioned at the straight portions 206b of the ring waveguide 206. In some embodiments, the first P/N junction 208 is positioned at one of the bending portions 206a of the ring waveguide 206 and the second P/N junction 212 is positioned at one of the straight portions 206b of the ring waveguide 206. In some embodiments, the first P/N junction 208 is positioned at one of the straight portions 206b of the ring waveguide 206 and the second P/N junction 212 is positioned at one of the bending portions 206a of the ring waveguide 206. In some embodiments, the first P/N junction 208 and the second P/N junction 212 are positioned at the bending portions 206a of the ring waveguide 206.

In some embodiments, as shown in FIG. 2, the light signal is further transmitted and/or coupled to an optical detector 218 after being modulated by the resonator 204 through the through port 202b of the first waveguide 202.

In some embodiments, the optical detector 218 is a photodiode detector. The optical detector 218 is optically coupled to the through port 202b of the first waveguide 202. As a result, the optical detector 218 may receive a small portion of the optical power of the light signal in the first waveguide 202 and convert the received light signal into a corresponding electrical output signal. In some examples, the optical detector 218 receives less than 10% of the optical power of the light signal in the first waveguide 202.

In some embodiments, the optical device 200 further includes a controller 250 electrically connected to the optical detector 218. The controller 250 is configured to store and process data from the optical detector 218. In some embodiments, the controller 250 includes software and hardware to store and process data from optical detector 218. In some embodiments, as illustrated in operation S130 of FIG. 1, the controller 250 detects a resonant spectrum of the light signal from the through port 202b of the first waveguide 202.

In some embodiments, the controller 250 is electrically connected and/or coupled to the first P/N junction 208 and is configured to apply the first bias voltage to the first P/N junction 208 through the first electrical pads 210 to modulate the light signal. In some embodiments, the controller 250 includes software and hardware for providing the first bias voltage to the first P/N junction 208.

In some embodiments, the controller 250 is electrically connected and/or coupled to the second P/N junction 212 and is configured to apply the second bias voltage to the second P/N junction 212 through the second electrical pads 214 to modulate the light signal. In some embodiments, the controller 250 includes software and hardware for providing the second bias voltage to the second P/N junction 212.

In some embodiments, the controller 250 is electrically connected and/or coupled to the first P/N junction 208 and the second P/N junction 212 and is configured to apply a bias voltage to the first P/N junction 208 and the second P/N junction 212 to modulate the light signal.

FIG. 3 illustrates a diagram of resonant spectrums of a light signal, according to embodiments of the present disclosure. As shown in the first resonant spectrum 301 of FIG. 3, the resonator 204 resonates at wavelength Δᵣ₁ when an effective refractive index of the resonator 204 is n_{eff1}. As shown in the second resonant spectrum 302 of FIG. 3, the resonator 204 resonates at wavelength 242 when the effective refractive index of the resonator 204 is n_{eff2}.

The full width at half maximum (FWHM) of the resonant spectrum depends on the effective refractive index of the resonator 204 is n_{eff1} as shown below in Equation I.

$$FWHM = \frac{( 1 - ra ) {λ}_{res}^{2}}{π {n}_{g} L \sqrt{ra}} , \qquad Equation I$$

In Equation I, n_{g} is the effective refractive index of the resonator 204, a is the round trip attenuation of the resonator 204, L is the roundtrip length of the resonator 204, r is the coupling coefficient between the first waveguide 202 and the resonator 204, and λᵣₑₛ is the resonant wavelength.

The free spectrum range (FSR) of the resonant spectrum also depends on the effective refractive index of the resonator 204 is n_{g} as shown below in Equation II.

$$FSR = \frac{{λ}^{2}}{{n}_{g} L} \qquad Equation II$$

In Equation II, n_{g} is the effective refractive index of the resonator 204, L is the length of the resonator 204, and λ is the vacuum wavelength of the light signal.

The extinction ratio (ER) of the resonant spectrum is a ratio between a maximum data transmission rate Tₘₐₓ and a minimum data transmission rate Tₘᵢₙ.

In some embodiments, as illustrated in operation S140 of FIG. 1, parameters of the optical device 200 are determined based on the resonant spectrum of the light signal. The parameters of the optical device include a phase shift, an optical loss, and an effective refractive index of the resonator. As shown in Equation I and Equation II, the phase shift, the optical loss, and the effective refractive index of the ring waveguide are correlated to the first resonant spectrum 301 and/or the second resonant spectrum 302. In some embodiments, the phase shift, the optical loss, and the effective refractive index of the resonator are determined based on the full width at half maximum (FWHM) of the resonant spectrum, the free spectrum range (FSR) of the resonant spectrum, and/or the extinction ratio (ER) of the resonant spectrum.

The resonant spectrum of the light signal is not sensitive to the variations in the fiber-grating coupling conditions. As such, optical parameters, such as the phase shift, the optical loss, and the effective refractive index of the resonator are not sensitive to the variations in the fiber-grating coupling conditions according to Equation I and Equation II.

Furthermore, the resonator 204 has a high-quality factor (Q-factor) and provides a phase shift with a much smaller footprint. In some embodiments, the optical device with the ring resonator has a diameter in the micrometer range.

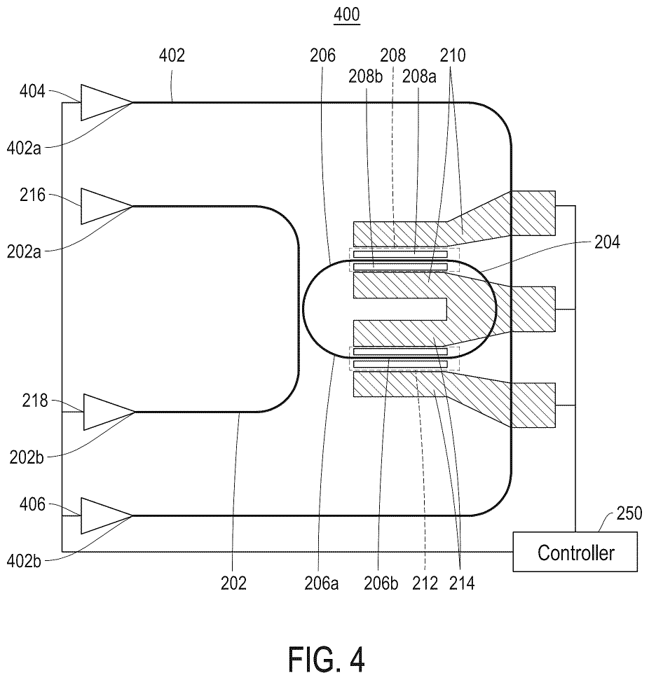

FIG. 4 illustrates a diagram of an optical device 400 used in the process flow 100 in FIG. 1, according to embodiments of the present disclosure. Components of the optical device 400 described herein correspond to the components of the optical device 200 as described in FIG. 2. In some embodiments, the optical device 400 is a test key for evaluating performance and creating a simulation program with integrated circuit emphasis (SPICE) models for circuit design.

In some embodiments, the optical device 400 is similar to the optical device 200, except that the optical device 400 further includes a second waveguide 402. The second waveguide 402 is configured to couple the light signal from the resonator 204 to the second waveguide 402.

In some embodiments, the second waveguide 402 is positioned adjacent to bending portions 206a to couple to the resonator 204.

In some embodiments, the second waveguide 402 is a bus waveguide. The second waveguide 402 includes an add port 402a and a drop port 402b. In some embodiments, the second waveguide 402 is configured to couple the light signal from the resonator 204 to the add port 402a and/or the drop port 402b of the second waveguide 402.

In some embodiments, as shown in FIG. 4, the light signal is further transmitted and/or coupled to an optical detector 404 after being modulated by the resonator 204 through the add port 402a of the second waveguide 402. In some embodiments, the light signal is further transmitted and/or coupled to an optical detector 406 after being modulated by the resonator 204 through the drop port 402b of the second waveguide 402.

In some embodiments, the optical detectors 404 and 406 are photodiode detectors. The optical detectors 404 and 406 are optically coupled to the add port 402a and/or the drop port 402b of the second waveguide 402. As a result, the optical detectors 404 and 406 may receive a small portion of the optical power of the light signal in the second waveguide 402 and convert the received light signal into a corresponding electrical output signal. In some examples, the optical detectors 404 and 406 receive less than 10% of the optical power of the light signal in the second waveguide 402.

In some embodiments, the controller 250 is configured to store and process data from the optical detectors 404 and 406. In some embodiments, the controller 250 includes software and hardware to store and process data from optical detectors 404 and 406. In some embodiments, the controller 250 detects resonant spectrums of the light signal from the add port 402a and/or the drop port 402b of the second waveguide 402.

In some embodiments, parameters of the optical device 400 are determined based on the resonant spectrums of the light signal. The parameters of the optical device include a phase shift, an optical loss, and an effective refractive index of the resonator 204. For example, the phase shift, the optical loss, and the effective refractive index of the ring waveguide are determined based on the full width at half maximum (FWHM) of the resonant spectrums, the free spectrum range (FSR) of the resonant spectrums, and/or the extinction ratio (ER) of the resonant spectrums.

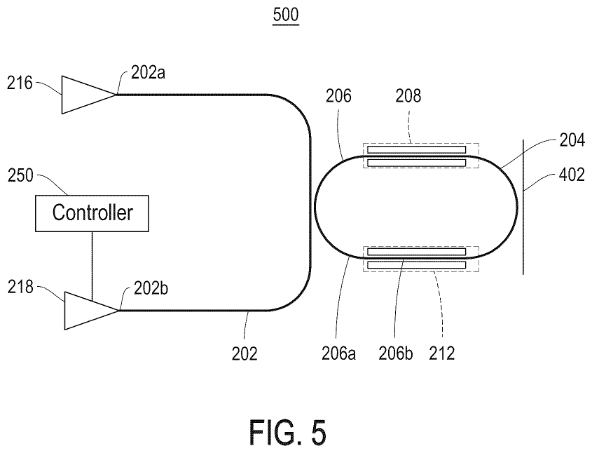

FIG. 5 illustrates a diagram of an optical device 500 used in the process flow 100 in FIG. 1, according to embodiments of the present disclosure. Components of the optical device 500 described herein correspond to the components of the optical device 400 as described in FIG. 4. For the sake of simplicity, FIG. 5 does not show the detailed structure of the second waveguide 402. Structures and functions of the second waveguide 402 described herein may be similar to the structures and functions of the second waveguide 402 as described in FIG. 4. In some embodiments, the optical device 500 is a test key for evaluating performance and creating a simulation program with integrated circuit emphasis (SPICE) models for circuit design.

In some embodiments, as shown in FIG. 5, the first P/N junction 208 is formed by doping a portion of the ring waveguide 206 to modulate a resonant frequency of the resonator 204, such that the light signal is resonant at a resonant wavelength λᵣ in the resonator 204. Similarly, the second P/N junction 212 is formed by doping another portion of the ring waveguide 206 to modulate the resonant frequency of the resonator 204, such that the light signal is resonant at the resonant wavelength 2 in the resonator 204. The optical device 500 does not have electrical pads for the first P/N junction 208 or the second P/N junction 212 for further modulating the resonant frequency of the resonator 204. As such, the size of the optical device 500 is further reduced in regard to the optical device 400 of FIG. 4.

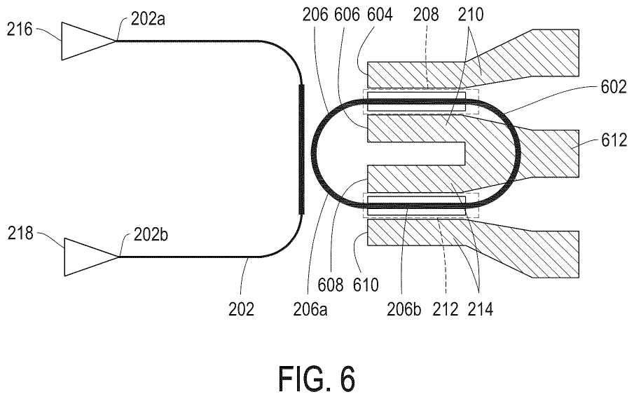

FIG. 6 schematically illustrates an example resonator 602 used in the process flow 100 in FIG. 1, according to embodiments of the present disclosure. Components of the resonator 602 described herein correspond to the components of the resonator 204 as described in FIG. 2.

In some embodiments, as shown in FIG. 6, the first electrical pads 210 include a first ground pad 604 and a first surface pad 606 configured to apply the first bias voltage to the first P/N junction 208. The first electrical pads 210 are positioned adjacent to one of the straight portions 206b of the ring waveguide 206.

In some embodiments, the second electrical pads 214 include a second ground pad 610 and a second surface pad 608 configured to apply the second bias voltage to the second P/N junction 212. The second electrical pads 214 are positioned adjacent to one of the straight portions 206b of the ring waveguide 206. In some embodiments, the first electrical pads 210 and the second electrical pads 214 are positioned adjacent to different straight portions of the ring waveguide 206.

In some embodiments, as shown in FIG. 6, the first surface pad 606 and the second surface pad 608 are electrically connected to each other. In some embodiments, the first surface pad 606 and the second surface pad 608 are electrically connected to a shared pad 612.

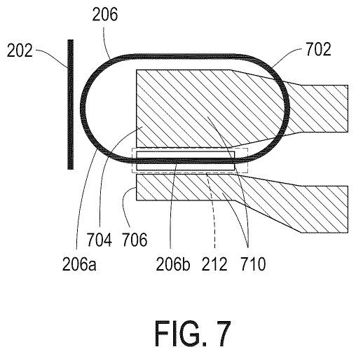

FIG. 7 schematically illustrates an example resonator 702 used in the process flow 100 in FIG. 1, according to embodiments of the present disclosure. Components of the resonator 702 described herein correspond to the components of the resonator 204 as described in FIG. 2. For the sake of simplicity, FIG. 7 does not show the detailed structure of the first waveguide 202.

In some embodiments, as shown in FIG. 7, the resonator 702 includes only one P/N junction 212 positioned adjacent to a straight portion 206b of the ring waveguide 206. In some embodiments, the electrical pads 710 include a surface pad 704 and a ground pad 706 configured to apply a bias voltage to the P/N junction 212. The electrical pads 710 are positioned adjacent to the straight portion 206b of the ring waveguide 206 in some embodiments.

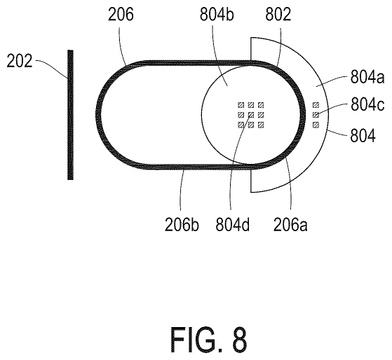

FIG. 8 schematically illustrates an example resonator 802 used in the process flow 100 in FIG. 1, according to embodiments of the present disclosure. Components of the resonator 802 described herein correspond to the components of the resonator 204 as described in FIG. 2. For the sake of simplicity, FIG. 8 does not show the detailed structure of the first waveguide 202.

In some embodiments, as shown in FIG. 8, the resonator 802 includes a P/N junction 804 positioned adjacent to a bending portion 206a of the ring waveguide 206. The P/N junction 804 is formed by doping a portion of the ring waveguide 206 to modulate a resonant frequency of the resonator 802, such that the light signal is resonant at a resonant wavelength λᵣ in the resonator 802. A doping concentration of the P/N junction 804 may be varied to modulate the light signal in the resonator 802.

In some embodiments, as shown in FIG. 8, the P/N junction 804 includes a first doped portion 804a and a second doped portion 804b to form the P/N junction 804. In some embodiments, a portion of the ring waveguide 206 is doped to form the first doped portion 804a and the second doped portion 804b. In some embodiments, the first doped portion 804a and the second doped portion 804b are formed and positioned adjacent to the bending portion 206a of the ring waveguide 206.

In some embodiments, the P/N junction 804 further includes a first electrical contact 804c and a second electrical contact 804d configured to apply a bias voltage to the P/N junction 804. The first bias voltage is applied to the P/N junction 804, such that a depletion region forms within the ring waveguide 206. The size of the depletion region changes when the bias voltage changes, thereby changing the effective refractive index of the ring waveguide 206. The modulation of the effective refractive index modulates the resonant wavelength of the ring waveguide 206 accordingly, which changes the transmittance of the first waveguide 202 at the corresponding carrier wavelength, thereby modulating the intensity thereof and generating the corresponding resonant spectrum of the light signal. In some embodiments, the bias voltage is in a range from 0 volts to 0.7 volts. In some embodiments, the bias voltage is in a range from 0 volts to 0.3 volts.

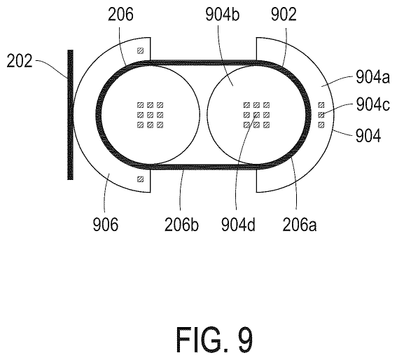

FIG. 9 schematically illustrates an example resonator 902 used in the process flow 100 in FIG. 1, according to embodiments of the present disclosure. Components of the resonator 902 described herein correspond to the components of the resonator 204 as described in FIG. 2. For the sake of simplicity, FIG. 9 does not show the detailed structure of the first waveguide 202.

In some embodiments, as shown in FIG. 9, the resonator 902 includes a first P/N junction 904 positioned adjacent to one bending portion 206a of the ring waveguide 206. A doping concentration of the first P/N junction 904 may be varied to modulate the light signal in the resonator 902.

In some embodiments, as shown in FIG. 9, the first P/N junction 904 includes a first doped portion 904a and a second doped portion 904b to form the first P/N junction 904. In some embodiments, a portion of the ring waveguide 206 is doped to form the first doped portion 904a and the second doped portion 904b. In some embodiments, the first doped portion 904a and the second doped portion 904b are formed and positioned adjacent to the bending portion 206a of the ring waveguide 206.

In some embodiments, the first P/N junction 904 further includes a first electrical contact 904c and a second electrical contact 904d configured to apply a bias voltage to the first P/N junction 904. The first bias voltage is applied to the first P/N junction 904, such that a depletion region forms within the ring waveguide 206. The size of the depletion region changes when the bias voltage changes, thereby changing the effective refractive index of the ring waveguide 206. The modulation of the effective refractive index modulates the resonant wavelength of the ring waveguide 206 accordingly, which changes the transmittance of the first waveguide 202 at the corresponding carrier wavelength, thereby modulating the intensity thereof and generating the corresponding resonant spectrum of the light signal. In some embodiments, the bias voltage is in a range from 0 volts to 0.7 volts. In some embodiments, the bias voltage is in a range from 0 volts to 0.3 volts.

In some embodiments, the resonator 902 further includes a second P/N junction 906 positioned adjacent to another bending portion 206a of the ring waveguide 206. A doping concentration of the second P/N junction 906 may also be varied to further modulate the light signal in the resonator 902. Components of the second P/N junction 906 are similar to the components of the first P/N junction 904.

In some embodiments, the first P/N junction 904 and the second P/N junction 906 are positioned adjacent to different bending portions of the ring waveguide 206.

The resonators 802 and 902 do not have electrical pads for the first P/N junction 208 or the second P/N junction 212 for further modulating the resonant frequency of the resonators. As such, the size of the optical device is further reduced, such that the overall size of the optical device is reduced.

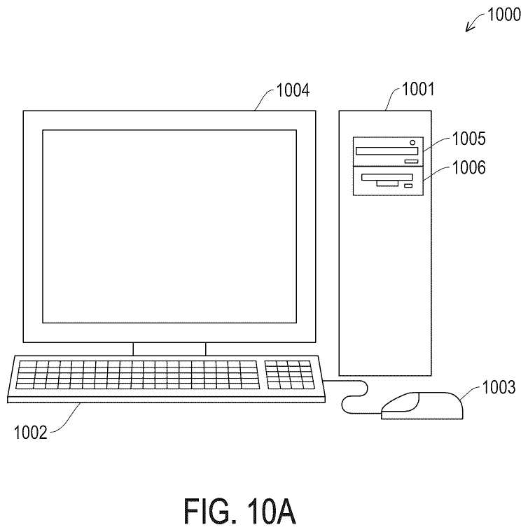

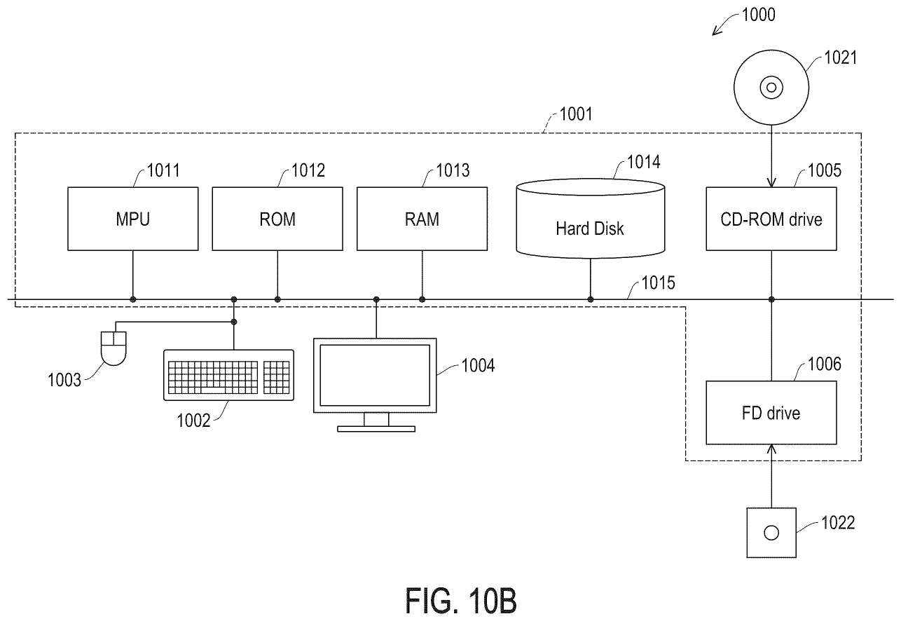

FIGS. 10A and 10B illustrate a computer system 1000 for operating an optical device (e.g., 200 of FIG. 2, 400 of FIG. 4, and 500 of FIG. 5), according to embodiments of the disclosure. In some embodiments, the computer system 1000 is used for performing the functions of the controller 250. In some embodiments, the computer system 1000 is used to execute the process flow 100 of FIG. 1. All of or a part of the processes, methods and/or operations of the foregoing embodiments can be realized using computer hardware and computer programs executed thereon.

In some embodiments, the process flow 100 or a portion of the process flow 100 is performed by the controller 250. In some embodiments, the process flow 100 or a portion of the process flow 100 is performed and/or is controlled by a computer system 1000 described below with respect to FIGS. 10A and 10B.

FIG. 10A is a diagram showing an external configuration of the computer system 1000. In FIG. 10A, a computer system 1000 is provided with a computer 1001 including an optical disk read only memory (e.g., CD-ROM or DVD-ROM) drive 1005 and a magnetic disk drive 1006, a keyboard 1002, a mouse 1003, and a monitor 1004.

FIG. 10B is a diagram showing an internal configuration of the computer system 1000. In FIG. 10B, the computer 1001 is provided with, in addition to the optical disk drive 1005 and the magnetic disk drive 1006, one or more processors, such as a micro processing unit (MPU) 1011, a ROM 1012 in which a program such as a boot up program is stored, a random access memory (RAM) 1013 that is connected to the MPU 1011 and in which a command of an application program is temporarily stored and a temporary storage area is provided, a hard disk 1014 in which an application program, a system program, and data are stored, and a bus 1015 that connects the MPU 1011, the ROM 1012, and the like. Note that the computer 1001 may include a network card (not shown) for providing a connection to a LAN.

The program for causing the computer system 1000 to execute the functions for operating the optical device (e.g., 200 of FIG. 2, 400 of FIG. 4, and 500 of FIG. 5), in the foregoing embodiments may be stored in an optical disk 1021 or a magnetic disk 1022, which are inserted into the optical disk drive 1005 or the magnetic disk drive 1006, and transmitted to the hard disk 1014. Alternatively, the program may be transmitted via a network (not shown) to the computer 1001 and stored in the hard disk 1014. At the time of execution, the program is loaded into the RAM 1013. The program may be loaded from the optical disk 1021 or the magnetic disk 1022, or directly from a network. The program does not necessarily have to include, for example, an operating system (OS) or a third-party program to cause the computer 1001 to execute the functions of the control system for operating the optical device (e.g., 200 of FIG. 2, 400 of FIG. 4, and 500 of FIG. 5) in the foregoing embodiments. The program may only include a command portion to call an appropriate function (module) in a controlled mode to obtain desired results.

The novel micro-ring modulators and the operating methods according to the present disclosure provide an improved optical modulator structure and methods of operating the same, thereby reducing the overall size of the modulator and maintaining the accuracy of determining the parameters of the optical modulator. Embodiments of the disclosure provide an improved optical modulator with a ring resonator, which has a bending waveguide that modulates the light signal by using a P/N junction within the ring resonator, to improve the accuracy of determining the parameters of the optical modulator and reduce the overall size of the modulator. Consequently, the modulation of optical signals can be improved, thereby enabling high-speed data communication for optical devices.

An embodiment of the disclosure is a method for determining parameters of an optical device including a first waveguide and a resonator. The method includes coupling a light signal from the first waveguide to the resonator. The resonator includes a first P/N junction and a ring waveguide, and the first P/N junction is configured to modulate a resonant frequency of the resonator until the light signal is resonant in the resonator. The method further includes detecting a resonant spectrum of the light signal from a through port of the first waveguide and determining parameters of the optical device based on the resonant spectrum of the light signal. In an embodiment, the method further includes coupling the light signal from a grating coupler to the first waveguide through an input port of the first waveguide. In an embodiment, parameters of the optical device include a phase shift, an optical loss, and an effective refractive index of the resonator. In an embodiment, the optical device further includes first electrical pads configured to apply a first bias voltage to the first P/N junction. In an embodiment, coupling the resonator to the first waveguide includes applying the first bias voltage to the first P/N junction to modulate an effective refractive index of the resonator. In an embodiment, the optical device further includes a second waveguide, and the method further includes coupling the light signal from the resonator to the second waveguide, wherein the second waveguide includes an add port, and detecting the resonant spectrum of the light signal from the add port of the second waveguide. In an embodiment, the second waveguide further includes a drop port, and the method further includes detecting the resonant spectrum of the light signal from the drop port of the second waveguide. In an embodiment, the ring waveguide includes straight waveguides and bending waveguides configured to form a loop, and the first P/N junction is positioned at the straight waveguides or the bending waveguides. In an embodiment, the resonator includes a second P/N junction positioned at the straight waveguides or the bending waveguides. In an embodiment, the optical device further includes second electrical pads configured to apply a second bias voltage to the second P/N junction. In an embodiment, coupling the resonator to the first waveguide includes applying the second bias voltage to the second P/N junction to further modulate an effective refractive index of the resonator.

Another embodiment of the disclosure is a method for determining parameters of an optical device including a first waveguide and a resonator. The method includes coupling a light signal from the first waveguide to the resonator. The resonator includes straight waveguides and bending waveguides that form a loop, and a P/N junction, and the P/N junction is configured to modulate a resonant frequency of the resonator. The method further includes detecting a resonant spectrum of the light signal from a through port of the first waveguide, and determining parameters of the optical device based on the resonant spectrum of the light signal.

Another embodiment of the disclosure is an optical device. The optical device includes a first waveguide, and a resonator configured to couple a light signal from the first waveguide to the resonator. The resonator includes a first P/N junction and a ring waveguide, and the first P/N junction is configured to modulate a resonant frequency of the resonator until the light signal is resonant in the resonator. The optical device further includes a detector configured to detect a resonant spectrum of the light signal from a through port of the first waveguide, and a controller configured to determine parameters of the optical device based on the resonant spectrum of the light signal.

The foregoing outlines features of several embodiments or examples so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments or examples introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method for determining parameters of an optical device including a first waveguide and a resonator, comprising:
coupling a light signal from the first waveguide to the resonator, wherein the resonator includes a first P/N junction and a ring waveguide, wherein the first P/N junction is configured to modulate a resonant frequency of the resonator until the light signal is resonant in the resonator;
detecting a resonant spectrum of the light signal from a through port of the first waveguide; and
determining parameters of the optical device based on the resonant spectrum of the light signal.

2. The method according to claim 1, further comprising:
coupling the light signal from a grating coupler to the first waveguide through an input port of the first waveguide.

3. The method according to claim 1, wherein the parameters of the optical device include a phase shift, an optical loss, and an effective refractive index of the resonator.

4. The method according to claim 1, wherein the optical device further includes first electrical pads configured to apply a first bias voltage to the first P/N junction.

5. The method according to claim 4, wherein:
coupling the resonator to the first waveguide includes applying the first bias voltage to the first P/N junction to modulate an effective refractive index of the resonator.

6. The method according to claim 1, wherein the optical device further includes a second waveguide, and the method further comprises:
coupling the light signal from the resonator to the second waveguide, wherein the second waveguide includes an add port; and
detecting the resonant spectrum of the light signal from the add port of the second waveguide.

7. The method according to claim 6, wherein the second waveguide further includes a drop port, and the method further comprises:
detecting the resonant spectrum of the light signal from the drop port of the second waveguide.

8. The method according to claim 1, wherein:
the ring waveguide includes straight waveguides and bending waveguides configured to form a loop, and
the first P/N junction is positioned at the straight waveguides or the bending waveguides.

9. The method according to claim 8, wherein the resonator includes a second P/N junction positioned at the straight waveguides or the bending waveguides.

10. The method according to claim 9, wherein the optical device further includes second electrical pads configured to apply a second bias voltage to the second P/N junction.

11. The method according to claim 10, wherein coupling the resonator to the first waveguide includes:
applying the second bias voltage to the second P/N junction to further modulate an effective refractive index of the resonator.

12. A method for determining parameters of an optical device including a first waveguide and a resonator, comprising:
coupling a light signal from the first waveguide to the resonator,
wherein the resonator includes straight waveguides and bending waveguides that form a loop, and a P/N junction, and
the P/N junction is configured to modulate a resonant frequency of the resonator;
detecting a resonant spectrum of the light signal from a through port of the first waveguide; and
determining parameters of the optical device based on the resonant spectrum of the light signal.

13. The method according to claim 12, wherein the parameters of the optical device include a phase shift, an optical loss, and an effective refractive index of the resonator.

14. The method according to claim 12, wherein the optical device further includes first electrical pads configured to apply a first bias voltage to the P/N junction.

15. The method according to claim 14, wherein:
coupling the resonator to the first waveguide includes applying the first bias voltage to the P/N junction to modulate an effective refractive index of the resonator.

16. The method according to claim 12, wherein the optical device further includes a second waveguide, and the method further comprises:
coupling the light signal from the resonator to the second waveguide, wherein the second waveguide includes an add port; and
detecting the resonant spectrum of the light signal from the add port of the second waveguide.

17. The method according to claim 16, wherein the second waveguide further includes a drop port, and the method further comprises:
detecting the resonant spectrum of the light signal from the drop port of the second waveguide.

18. An optical device, comprising:
a first waveguide;
a resonator configured to couple a light signal from the first waveguide to the resonator, wherein the resonator includes a first P/N junction and a ring waveguide, and the first P/N junction is configured to modulate a resonant frequency of the resonator until the light signal is resonant in the resonator;
a detector configured to detect a resonant spectrum of the light signal from a through port of the first waveguide; and
a controller configured to determine parameters of the optical device based on the resonant spectrum of the light signal.

19. The optical device according to claim 18, wherein:
the ring waveguide includes straight waveguides and bending waveguides configured to form a loop, and
the first P/N junction is positioned at the straight waveguides or the bending waveguides.

20. The optical device according to claim 19, wherein:
the resonator includes a second P/N junction positioned at the straight waveguides or the bending waveguides.
